(19) United States
(12) Patent Application Publication
(10) Pub. No.: US 2004/0011610 A1
(43) Pub. Date: Jan. 22, 2004

(54) Electronically controlled parking brake for a motor vehicle

(76) Inventors: Markus Witzler, Koblenz (DE); Kurt Füchtler, Bergisch Gladbach (DE); Walter Geltermair, Koblenz (DE)

Correspondence Address: MCDONNELL BOEHNEN HULBERT & BERGHOFF, 300 SOUTH WACKER DRIVE, SUITE 3200, CHICAGO, IL, 60606, US

(21) Appl. No.: 10/344,110

(22) PCT Filed: Aug. 8, 2001
(86) PCT No.: PCT/EP01/09178

(30) Foreign Application Priority Data
Aug. 9, 2000 (DE) 100 38 786.1

(51) Int. Cl. F16D 69/00

(52) U.S. Cl. 188/265; 188/158; 303/89; 303/20

(57) ABSTRACT

The invention relates to an electronically controlled parking brake for a motor vehicle, comprising a switch-on device (35) for generating an electronic activation signal, a release device (35) for generating an electronic deactivation signal, an electronic control device (25) that processes said signal, a pressure fluid source (14, 16, 21) and brake modules (2) that can be optionally linked with the pressure fluid source (14, 16, 21) via on-off valves (11, 12) and that generate braking forces on the wheels of the motor vehicle. Each brake module is provided with a first pressure compartment (34) that is contiguous with a tensioning member of the respective brake module, said pressure compartment being linkable with a main braking cylinder (23) via service brake circuit (22). Each brake module is further provided with a second pressure compartment (9) that is contiguous with a tensioning member of the respective pressure brake module, said pressure compartment being linkable with the pressure fluid source (14, 16, 21) via a separate hydraulic circuit (17, 18, 19, 20). In at least a part of the brake modules (2) the respective tensioning member is provided with two separate coaxially disposed pressure pistons (4, 5), one of which defines the first pressure compartment (34), and between which the second pressure compartment (9) is configured. The pressure fluid source is provided with a pressure accumulator (16) for accumulating the pressure fluid, and with a pressure generator (14) for filling the pressure accumulator (16) and the fluid reservoir (21). The hydraulic circuit comprises valve systems (11, 12) that are controlled by control signals supplied by the control device (25). Said valve systems optionally link the pressure outlet of the pressure accumulator (16) with the respective second pressure compartment (9) of the wheel brake modules (2) and optionally link the respective second pressure compartment (9) of the wheel brake modules (2) with the fluid reservoir (21). Said valve systems (11, 12) are controlled by the control signals of the control device (25).

The invention relates to a parking brake apparatus in accordance with the introductory portion of claim 1.

Parking brakes are installed in nearly all motor vehicles, primarily in order to secure the vehicle against an unintended rolling away. In addition, in the event of the absence of conventional brakes, the parking brake assumes the safety function of bringing the vehicle to a stop.

A parking brake device for a motor vehicle comprising a braking device that can be adjusted in a lever-like manner, by means of which the at least one vehicle brake can be activated, whereby the activation force of the vehicle brake is in proportion to the adjustment position of the activating device, and whereby the activating device comprises a changeable electrical switching element, in dependence on the position of which a hydraulic activating device can be stressed by means of an electrically activatable valve with a hydraulic fluid under pressure, is already known from DE 198 59 804. In the locking operation, the brakes are applied by means of draw springs which act on a piston in a working connection with the brake liners. A force acting against the draw springs, which reduces or eliminates the corresponding braking force of the draw springs, can be produced by means of an additional hydraulic connection with the second pressure chamber of the brake module.

In such a parking brake apparatus, it is disadvantageous that, upon the absence of the additional hydraulic circuit, an uncontrolled braking is automatically triggered by the draw springs, and that the apparatus requires many components.

It is the task of the invention to further develop an electrically activatable parking brake apparatus in such a manner that variable hydraulic braking pressures can be produced with a simple and secure construction, whereby the parameters of the condition of the vehicle, as well as of the stopping space, can be taken into consideration.

The task is solved, in accordance with the invention, by means of the characteristics of claim 1.

The valve devices can comprise a multi-path valve, or even a first pilot valve and a second pilot valve.

Dispensing with an activating lever, which is otherwise conventional and involves a considerable need for space within the vehicle space, and the separate supplying of pressure, which also makes it possible to bring the vehicle to a stop upon the complete absence of the conventional brake apparatus, are advantageous. In one additional development, the pressure condition of the wheel brake module is continuously monitored by means of suitable sensors. The sensor signals of a pressure regulating device (ABS), which is conventional at the present time, can also be used for this monitoring, whereby the dynamic [condition] as well as the static condition of the vehicle can be detected by means of the sensor signals. This can, for example, involve the detection of the stopping of the vehicle on an inclined surface, or the rolling away of the vehicle. It is also possible to facilitate the driving up of a slope by this means, since the parking brake is unlocked after exceeding a defined threshold through the detection of the tensile force of the engine.

Both of the pressure pistons can be positioned in tandem one behind the other, or even be inserted telescopically into one another.

The electrical activation of the parking brake offers a series of possibilities that can not be achieved with a conventional, manually activated parking brake. Thus, the activation device can be connected with a sensor corresponding to the condition of the door lock in the driver's door and/or a sensor corresponding to the condition of the ignition lock and/or a sensor corresponding to the load condition of the driver's seat, whereby an activation signal can be produced in dependence upon the signal of at least one of the sensors. Thus, for example, the parking brakes can be automatically triggered if the driver's door is closed and blocked, or if the driver's door and the ignition key are removed, or if the driver's seat is relieved of weight—that is to say, if the driver has gotten out of the vehicle. The various sensor signals can also be connected with one another.

Depending on the condition of the vehicle, it is possible to react flexibly by means of a variable configuration or reduction of the braking pressure, as the case may be.

Advantageous configurations of the invention are stated in the sub-claims.

Additional characteristics and advantages are the object of the following description and of the depictions in the diagrams. These depict the following:

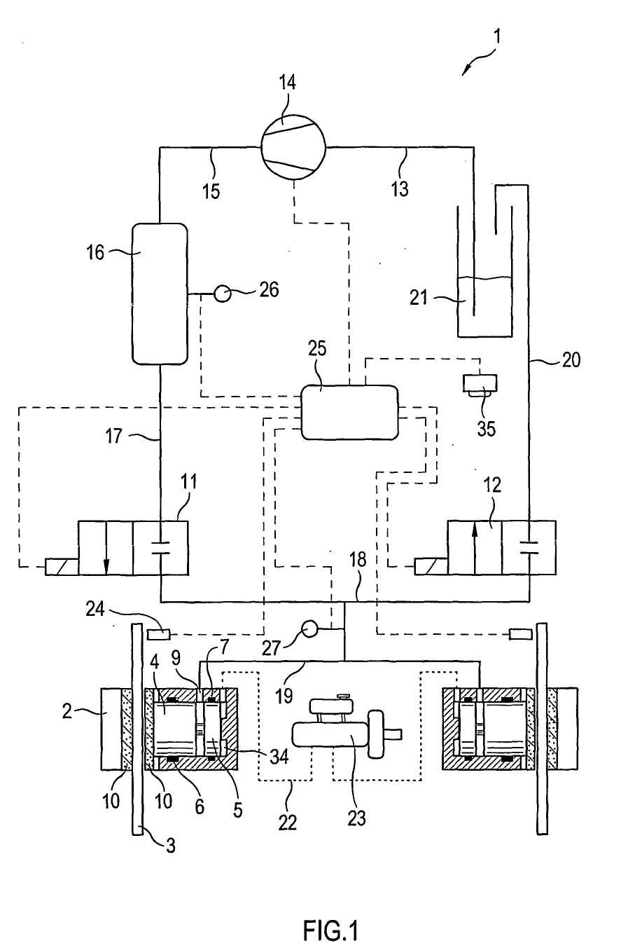

FIG. 1: The apparatus in accordance with the invention in the release position;

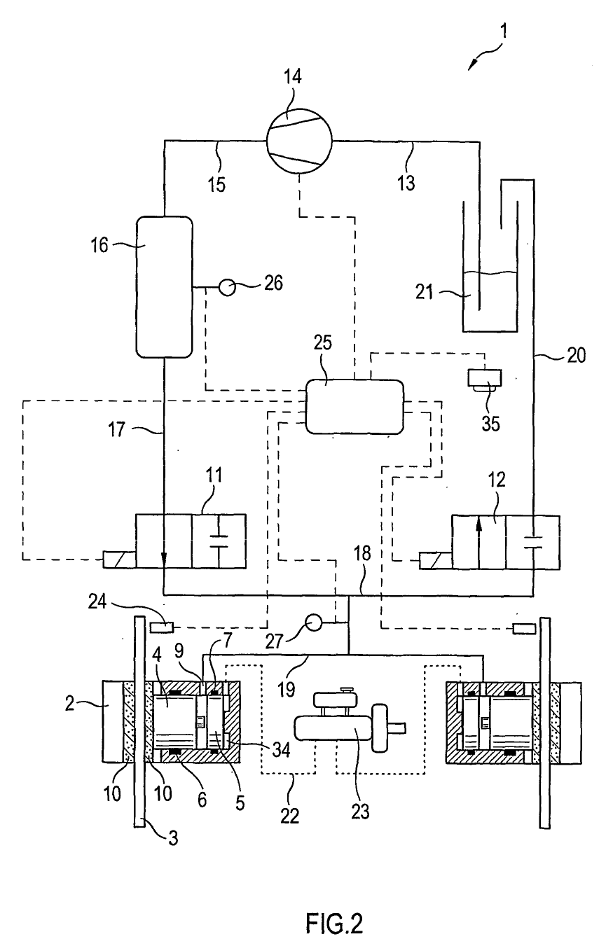

FIG. 2: The apparatus in accordance with the invention during the activation of the parking brake;

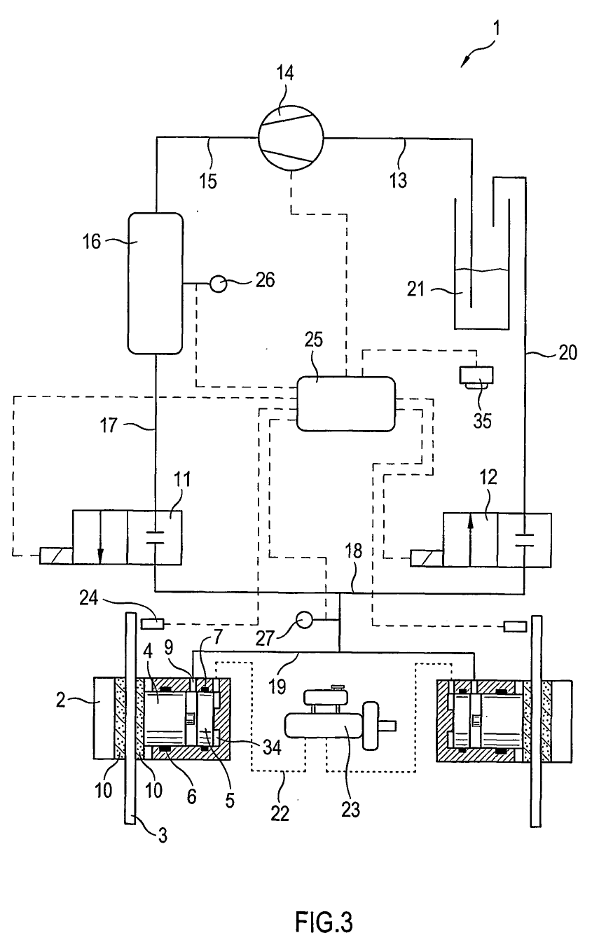

FIG. 3: The apparatus in accordance with the invention with the parking brake in the stopping position;

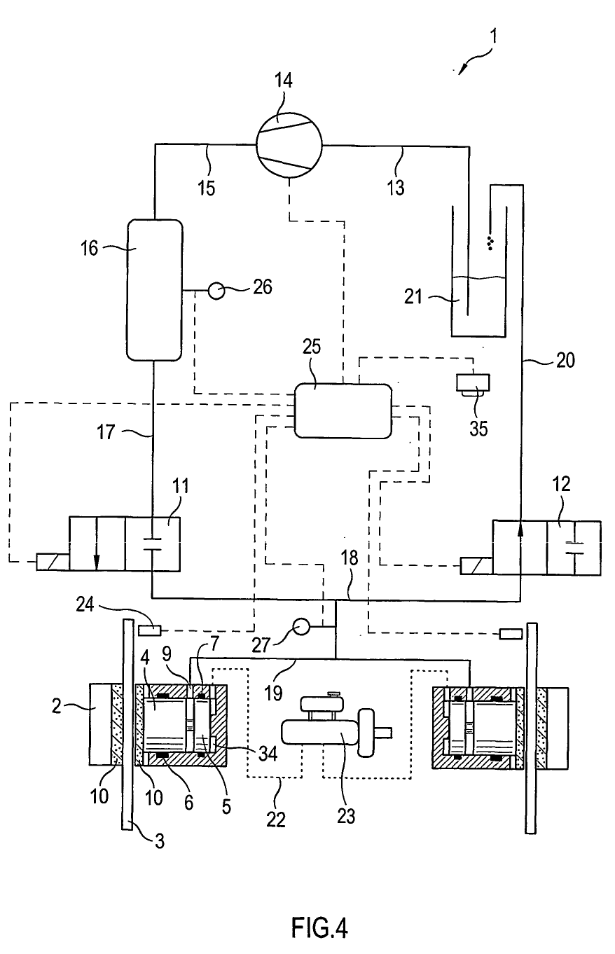

FIG. 4: The apparatus in accordance with the invention upon the release of the parking brake;

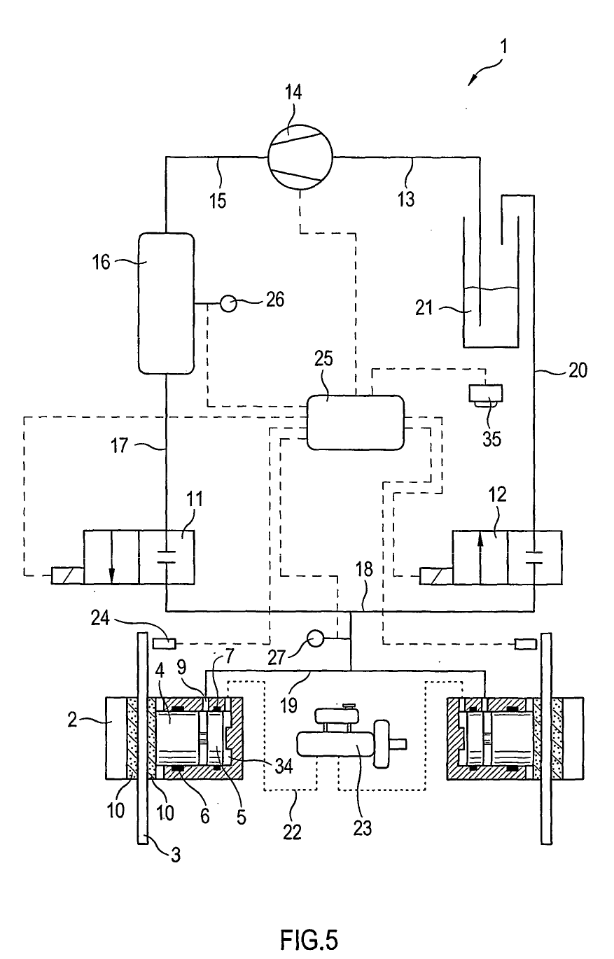

FIG. 5: The apparatus in accordance with the invention during an activation of the operating brake;

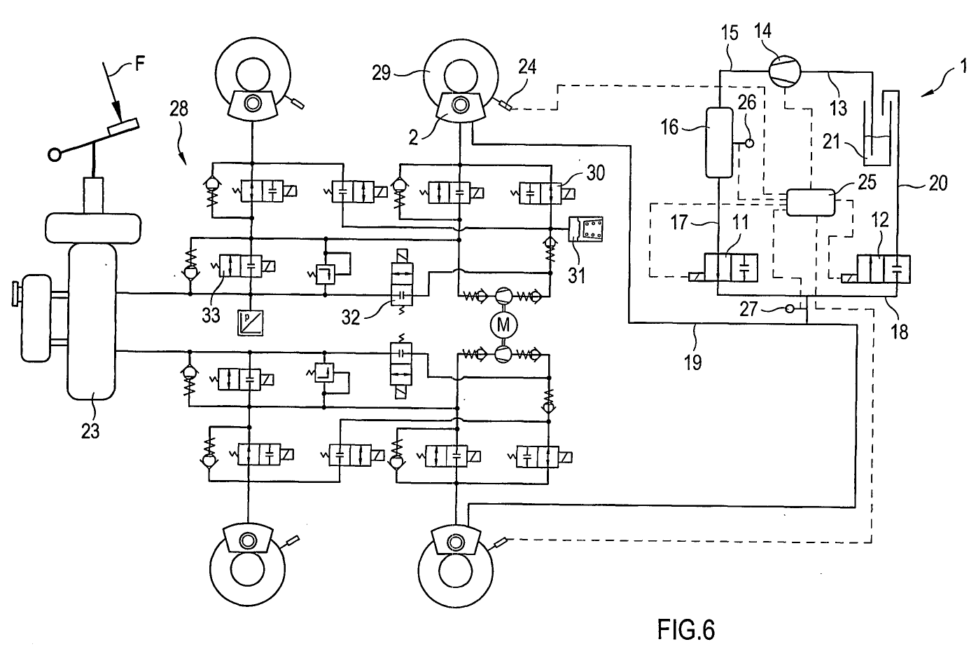

FIG. 6: The use of the apparatus in accordance with the invention in a working connection with a pressure regulating device (ABS); and:

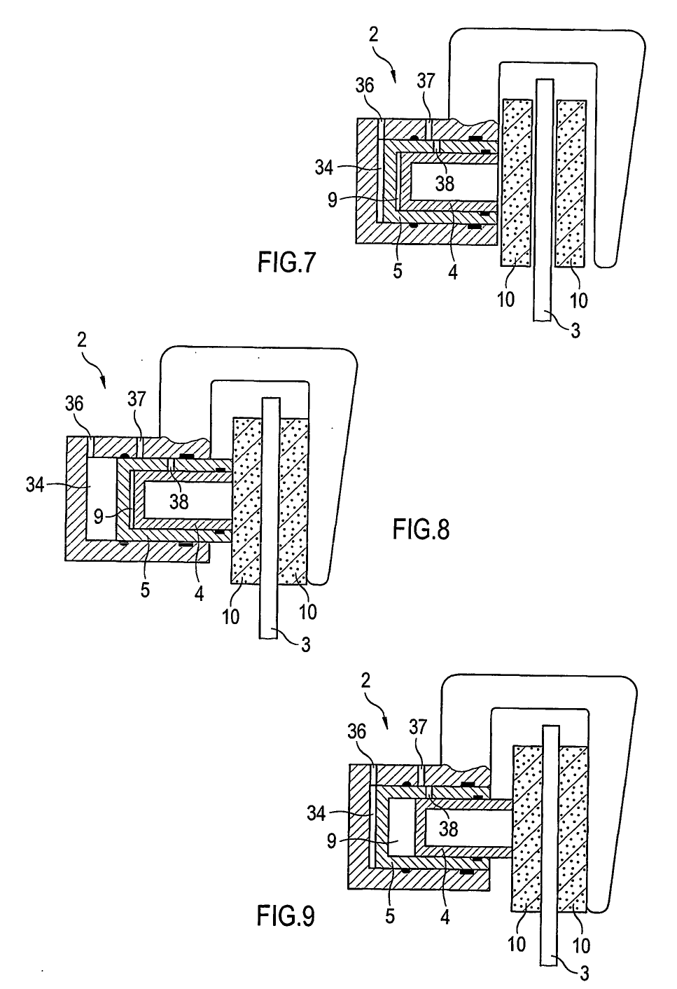

FIGS. 7 to 9: A schematic diagram of a modified form of implementation of a brake module suitable for the parking brake in accordance with the invention, in three different conditions.

The invention is, for the sake of simplicity, explained through its use in a brake module 2, since the construction and the process are the same for the additional brake module(s).

The electronically controlled parking brake in accordance with the invention has a locking apparatus 1 which is connected, by way of hydraulic pressure lines 18, 19, with the wheel brake modules 2. The brake modules are, for example, thereby wheel brakes of the rear axis and/or of the front axis of a motor vehicle, or a suitable combination of these wheel brakes which is able to lock the vehicle in its specific position.

The casing of the wheel brake module 2 is, in the broadest sense, already known from the state of the art or is, as the case may be, already installed in motor vehicles in millions of copies as a so-called “floating caliper brake”, and is configured in such a manner that it has a borehole which accommodates a front pressure piston 4 and a rear pressure piston 5, whereby the pressure pistons are encompassed by sealing elements 6, 7 and are sealed off against the casing. Between the front pressure piston 4 and the rear pressure piston 5, an intermediate chamber 9 is formed by means of a specific spacing extension 8, which is integrally formed with the front pressure piston 4 or is, optionally, also integrally formed with the rear pressure piston 5. This hydraulically isolated intermediate chamber 9 is in direct hydraulic connection, by way of a supply borehole, with the pressure line 19 of the electronically controlled locking apparatus 1, and can be acted upon by the same, while the front surface of the rear pressure piston 5 borders a pressure chamber 34 which is, by way of the pressure line 22, in a hydraulic working connection with a conventional primary brake cylinder 23.

A conventional brake liner 10, which acts on the brake disk 3 under pressure stressing or clamps this by means of a known floating caliper brake, as the case may be, in coordination with the brake liner 10 positioned opposite to it in order to produce a friction force, is located in a position in front of the pressure piston 4.

A locking apparatus 1—which has a pressure generator 14, a pressure reservoir 16, a pilot valve 11, a pilot valve 12, and a fluid reservoir 21—is provided for the optional pressure stressing of the wheel brake modules 2. A suction line 13 connected with the pressure generator 14 (such as the motor/pump unit, for example) thereby allows the pressure generator 14 to remove fluid from the fluid reservoir 21.

The pressure generator 14 fills the pressure reservoir 16 by way of the pressure line 15, which [pressure reservoir] is, in turn, hydraulically connected with the pilot valve 11 by way of a pressure line 17. The pilot valve 11 controls the release of pressure from the pressure reservoir 16 into the pressure line 18 or into the connected pressure line 19 to the specific intermediate chamber 9 of the wheel brake modules 2, as the case may be. The pilot valve 11 is thereby configured as an electromagnetically switchable 2/2-way valve. The switching of the pilot valve 11 thereby takes place in dependence on the control signals of a connected electronic control device 25 which, among other tasks, converts the switching commands of the driver into electrical signals.

An additional pilot valve 12, which can, in an optional manner, relieve the pressure in the pressure line 18 by way of the return line 20 to the fluid reservoir 21, is likewise located in a manner coordinated with the pressure line 18. The pilot valve 12 is thereby likewise configured as an electromagnetically switchable 2/2-way valve. The switching of the pilot valve 12 thereby takes place in dependence on the control signals of a connected electronic control device 25 which, among other tasks, converts the switching commands of the driver into electrical signals.

For the monitoring of the load condition of the pressure reservoir 16, this has a pressure sensor 26, the signals of which are processed by the electronic control device 25 so that, upon a drop of the pressure level in the pressure reservoir 16 below a defined value, the pressure generator 14 is set into operation in order to bring the pressure in the pressure reservoir 16 back to its nominal value again.

Furthermore, a pressure sensor 27 is connected with the pressure line 18, the signals of which represent the pressure condition in the intermediate chamber 9 of the wheel brake module 2. This signal can be interpreted by the electronic control device 25 as the braking value that is actually acting upon the wheel. A drop of this braking value below a defined minimum value can set an automatic adjustment into operation which, in dependence on the pressure available in a wheel brake module 2, triggers an opening of the pilot valve 11 in order to increase the pressure in the wheel brake module 2 to a theoretical value again.

If the slope or the gradient in the roadway on which the vehicle is to be parked is detected, then the electronic control device 25 automatically selects a higher or a lower pressure theoretical value in dependence on the incline and, by way of the adjustment noted above, brings about the adjustment of this pressure value on the wheel brake module 2.

The signals of the wheel rotational speed sensors 24 of a pressure regulating device (ABS) can additionally be used for further protection against an unintended rolling away of the vehicle. An increased pressure in the wheel brake module 2 is thereby produced automatically if a rolling away of the vehicle is detected by the wheel rotational speed sensors 24. In order to rule out error signals, the increase in pressure that is thereby initiated upon reaching a defined maximum value is interrupted.

In the resting position of the system depicted in FIG. 1, both of the pilot valves 11, 12 are closed—that is to say, the connection of the pressure reservoir 16 to the pressure line 18, as well as the connection of this to the fluid reservoir 21, is interrupted and the intermediate chamber 9 becomes free of pressure.

If the parking brake is now activated by the driver through the activation of a switch 35 (FIG. 2), the pilot valve 11 is switched into a discharge position by the electronic control device 25, and a connection of the intermediate chamber 9 with the pressure reservoir 16 is produced. In order to achieve a controlled build-up of pressure, the pilot valve 11 can also be opened in accordance with a pulse rate model proceeding at short time intervals and then opened again and, specifically so, for long enough until the pressure desired in the intermediate chamber 9 is set. The pressure is thereby determined by means of a pressure sensor 27.

Through the increase in pressure in the intermediate chamber 9, the pressure pistons 4, 5 are forced away from one another, whereby the pressure piston 5 must necessarily be displaced up to its catch unit in the base of the borehole. This is the case, above all, if a braking pressure has already been produced in the system before the triggering of the parking brake by the brake pedal, such as upon stopping on a slope, for example.

The pressure piston 4 thereby acts in the usual manner on the brake liner 10, which clamps a brake disk 3 in the manner of a floating caliper brake.

After reaching a defined pressure in the intermediate chamber 9, as measured by means of the pressure sensor 27, the electronic control device 25 switches the pilot valve 11 into a blocking position in accordance with FIG. 3. Since the pilot valve 12 is also in a blocking position, the pressure in the wheel brake module 2 is consequently restricted. Both pilot valves 11, 12 are so-called currentless closed solenoid valves—that is to say, no stressing of the pilot valves 11, 12 by current is necessary in order to maintain these switching positions in a “pressure-restrained manner”.

The locking apparatus 1 is also still active in this parking position—that is to say, the pressure condition can additionally be permanently monitored by means of the pressure sensor 27. If the pressure should fall below a defined theoretical value, then an increase in the pressure can automatically be initiated by opening the pilot valve 11.

If the parking brake is now deactivated by the driver (FIG. 4), the electronic control device 25 switches the pilot valve 12 into a discharge position, through which the pressure of the intermediate chamber 9 can be relieved, by way of the return line 20, into the fluid reservoir 21. A complete relief is thereby monitored by means of the pressure sensor 27. Only subsequently is the pilot valve 12 switched back into its blocking position by the electronic control device 25. It is thereby ensured that the parking brake has been released completely.

The movement of the pressure pistons 4, 5 upon a normal activation of the brake is depicted in FIG. 5. A braking pressure is thereby fed, by way of the primary brake cylinder 23 and the pressure line 22, into the pressure chamber 34 behind the pressure piston 5. The pressure forces are conveyed to pressure pistons 4 by means of a mechanical coupling by way of a projection of the pressure piston 4, which [projection] conveys its forces onto the brake liners 10 clamping the brake disk 3 in the usual manner.

If the parking brake is activated out of the normal brake position in accordance with FIG. 5, then the pressure piston 5 is displaced back by the pressure flowing into the intermediate chamber 9 against the pressure in the brake circuit opposite to the direction of its activation and up to the catch unit. Normally, this backwards displacement brings about an equivalent backwards movement of the brake pedal against the driver's foot which could, under certain conditions, be perceived to be negative.

In order to avoid this, the pressure regulating system (ABS) which are already present in most vehicles can be used, for example. In this, it is necessary for this system to have at least one switch valve 30, 32, 33, as well as an expansion chamber 31. Through the switching of the switch valve 30 over into the discharge position, as well as the switching of the switch valves 32, 33 into a blocking position; the above-stated braking pressure that was previously fed in is discharged into the expansion chamber 31. The brake pedal is thereby hydraulically disconnected by the blocking position of the switch valves 32, 33, and the backwards displacement of the brake pedal noted above is prevented.

FIGS. 7 to 9 depict an additional form of implementation of a brake module in a schematic manner, whereby identical parts, or parts acting in the same manner, are again provided with the same reference numbers. The solution in accordance with FIGS. 7 to 9 differs from the solution in accordance with FIGS. 1 to 6 through the fact that the pistons 4 and 5 are not positioned in tandem one after the other but are, instead, guided into one another in a telescoping manner. The intermediate chamber 9 is consequently located between the base of the bowl-shaped piston 5 and the piston 4 that is guided into it in a telescopically displaceable manner. The supplying of hydraulic fluid to the pressure chamber 34 is carried out by way of an opening 36, while the supplying of hydraulic fluid to the intermediate chamber 9 is made possible by way of the openings 37 and 38.

FIG. 7 depicts the brakes in the unlocked condition, whereby both pistons 4 and 5 are drawn back. FIG. 8 depicts the brake apparatus upon the activation of the service brake—thus, if the pressure chamber 34 is acted upon with pressure and the piston 5 is displaced. FIG. 9, finally, depicts the apparatus upon the activation of the parking brake—thus, if the intermediate chamber 9 is acted upon with pressure and the piston 4 is displaced.

The above description shows that the solution in accordance with the invention is, in terms of its construction and its activation, extremely simple and economical in space. Thus, the necessary control commands can also be easily integrated into existing controls. Since the parking brake in accordance with the invention works with existing brake modules to a large degree, it is not only economical to manufacture, but can also easily be designed as a four-wheel brake with an ABS part. The braking pressure can correspond to the usual pressure of service brakes. The parking brake can thereby be operated with full braking pressure, while the braking force of conventional handbrakes amounts to a maximum of 30% of a service brake. The parking brake in-accordance with the invention can thus be used as a high-value emergency-braking system.

As described above, an adjustment of the parking brake is dispensed with, since the parking brake always adjusts itself through the monitoring of the pressure. It can also not happen that the braking force drops after the cooling off of the wheels and brakes. Since the parking brake works in an electrohydraulic manner, the cable tighteners that are necessary in the case of hand brakes working with brake cables are also dispensed with. Because of the lack of brake cables, the parking brake in accordance with the invention can also not jam.

Since the same braking pressure acts on all of the wheels that are braked, the brake can not draw off towards one side. The parking brake can, if necessary, also be activated by means of a buffer battery. As was explained above, no current is needed to stop the parking brake.

All of the parts that are required for the construction of the parking brake are known from conventional brake systems, so that mass-produced parts can be used, which keeps the costs for the parking brake in accordance with the invention low. The brake can be retrofitted at any time. Because of the small number of parts specifically required for the parking brake, and because of the low braking value of these parts, the unsprung masses are only increased to an insignificant degree or not at all.

1. An electronically controlled parking brake for a motor vehicle, comprising an activation device (35) for the production of an electronic activation signal, a releasing device (35)⁽¹⁾ for the production of an electronic deactivation signal, an electronic control device (25) processing these signals, a hydraulic fluid source (14, 16, 21), and brake modules (2) for the production of the braking forces on the wheels of the vehicle, which [brake modules] can, in an optional manner, be connected with a first pressure chamber (34) by way of pilot valves (11, 12), each bounding with a clamping element of the specific brake module, which [pressure chamber] can be connected, by way of an operating brake circuit (22), with a primary brake cylinder (23) and with a second pressure chamber (9) bounding on the specific clamping element, which [pressure chamber] can be connected with the hydraulic fluid source (14, 16, 21) by way of a separate hydraulic circuit (17, 18, 19, 20), characterized in that, on at least a portion of the brake module (2), the specific clamping element encompasses two pressure pistons (4, 5) separately positioned in a coaxial manner, one of which [pistons] bounds the first pressure chamber (34) and between which the second pressure chamber (9) is configured, that, the hydraulic fluid source encompasses a pressure reservoir (16) for the storage of the hydraulic fluid, a pressure generator (14) for filling the pressure reservoir (16), and a fluid reservoir (21), and that, valve devices (11, 12), which can be controlled by control signals of the control device (25) for the optional connecting of the pressure outlet of the pressure reservoir (16) with the specific second pressure chamber (9) of the wheel brake modules (2) and for the optional connecting of the specific second pressure chamber (9) of the wheel brake modules (2) with the fluid reservoir (21), are positioned in the hydraulic circuit.
(1) [/Sic, “35”, same reference number as the previous item/].

2. A parking brake in accordance with claim 1, charact riz d in that, both of the pressure pistons (4, 5) are positioned in tandem one behind the other.

3. A parking brake in accordance with claim 1, characterized in that, both of the pressure pistons (4, 5) are guided telescopically into one another.

4. A parking brake in accordance with one of the claims 1 to 3, characterized in that, the valve apparatus encompasses a first and a second pilot valve (11, 12).

5. A parking brake in accordance with claim 4, characterized in that, the pilot valves (11, 12) are designed as 2/2-way valves and can occupy a passage [position] or a blocking position, respectively.

6. A parking brake in accordance with claim 4 or 5, characterized in that, the pilot valves (11, 12) are configured as solenoid valves.

7. A parking brake in accordance with claim 6 characterized in that, the pilot valves (11, 12) occupy a blocking position in a currentless manner.

8. A parking brake in accordance with one of the claims 1 to 7, characterized in that, a pressure sensor (27) for monitoring the pressure fed into the second pressure chamber (9) is connected to the hydraulic circuit.

9. A parking brake in accordance with claim 8, characterized in that, at least one defined theoretical value can be preset for the pressure fed in.

10. A parking brake in accordance with claim 9, characterized in that, the theoretical value is formed in dependence on the inclination of the road, and that, the control device (26) is configured in such a manner that, upon falling short of the theoretical value, the pressure is automatically increased, through an opening of the first pilot valve (11), for long enough until the theoretical value is at least achieved again.

11. A parking brake in accordance with claim 10, characterized in that, the theoretical value is permanently monitored, even when the vehicle is stopped, and is subsequently adjusted upon need.

12. A parking brake in accordance with claim 10 or 11, characterized in that, means are provided by means of which, in the event of a non-successful reproduction of the theoretical value of the pressure, a warning signal is conveyed to the driver.

13. A parking brake in accordance with one of the claims 1 to 12, characterized in that, when the parking brake apparatus is activated by means of the wheel rotational speed sensors (24) of the pressure regulating device (ABS), the vehicle wheels are permanently monitored for movement, and that, upon detection of a movement, the pressure in the second pressure chamber (9) is adjusted to a higher pressure value.

14. A parking brake in accordance with one of the claims 1 to 13, characterized in that, the activation device is connected with a sensor responding to the condition of the door lock of the driver door and/or a sensor responding to the condition of the ignition lock and/or a sensor responding to the load condition of the driver seat, and that, an activation signal can be produced in dependence upon a signal of at least one of the sensors.

15. A parking brake in accordance with one of the claims 1 to 14, characterized in that, a deactivation signal can be produced in dependence upon the output signal of a sensor detecting the operating condition of the motor vehicle.

16. A process for controlling an electronically controlled parking brake in accordance with one of the claims 1 to 15, characterized in that, upon the triggering of the parking brake apparatus, the primary brake cylinder (23) is hydraulically separated from the corresponding operating brake circuit.

17. A process for controlling an electronically controlled parking brake for a motor vehicle in accordance with claim 16, characterized in that, the brake circuits corresponding to the primary brake cylinder (23) are separated by means of the pilot valves (32, 33) of a pressure regulating device (ABS).

18. A process for controlling an electronically controlled parking brake for a motor vehicle in accordance with claim 17, characterized in that, after the separation of the primary brake cylinder (23), the pressure possibly present in the first pressure chambers (34) of the wheel brake modules (2), which is produced by the primary brake cylinder (23), is released by opening the pilot valves (30) of the pressure regulating device (ABS) in the expansion chamber of the same.
